(19) United States
(12) Patent Application Publication
(10) Pub. No.: US 2019/0199526 A1
(43) Pub. Date: Jun. 27, 2019

(54) COMMUNICATION SYSTEM AND DATA COMMUNICATION METHOD

(71) Applicant: MegaChips Corporation, Osaka (JP)

(72) Inventors: Takahiko SUGAHARA, Osaka-Shi (JP); Naoki MATSUYAMA, Osaka-shi (JP)

(73) Assignee: MegaChips Corporation, Osaka (JP)

(21) Appl. No.: 16/233,171

(22) Filed: Dec. 27, 2018

(30) Foreign Application Priority Data
Dec. 27, 2017 (JP) 2017-250596

(51) Int. Cl. H04L 9/08; H04L 9/06; H04L 9/00

(52) U.S. Cl. CPC H04L 9/0869; H04L 9/0662; H04L 2209/12; H04L 9/003; H04L 9/0816

(57) ABSTRACT

In transmission of command from a host device to a memory device, circuitry is configured to selectively switch between a first pattern and a second pattern. In the first pattern, an encrypted command is generated by encrypting a command with an S-box circuit of a first encryption unit, and the encrypted command is decrypted with an InvS-box circuit of a second decryption unit. In the second pattern, an encrypted command is generated by encrypting a command with an InvS-box circuit of a first decryption unit, and the encrypted command is decrypted with an S-box circuit of a second encryption unit.

### CROSS REFERENCE TO RELATED APPLICATIONS

The present application is based on, and claims priority from Japanese Patent Application Serial Number 2017-250596, the disclosure of which is hereby incorporated by reference herein in its entirety.

### BACKGROUND

### Technical Field

The present disclosure relates to a communication system including a first communication device and a second communication device, and method for data communication between the first and the second communication devices.

### Related Art

Cryptosystems currently in use are perceived to be computationally secure against cryptanalysis. Actually providing a cryptographic module with an encryption device, however, may result in leaks caused by providing the module, such as power consumption and processing time. Threats of side channel attacks are increasing, in an attempt to illicitly obtain secret information such as secret keys by observing these operational conditions by various physical means.

Examples of side channel attacks include power analysis attacks which are conducted to analyze secret information by measuring the power consumption of a device. There is a report that Differential Power Analysis (DPA) and Correlation Power Analysis (CPA), which are an analysis of power consumption measurements by statistical functions, are one of the most powerful attacks among such side channel attacks. See Paul Kocher et al. “Introduction to Differential Power Analysis and related Attacks,” [online], Cryptography Research, searched in the Internet on Dec. 1, 2017, <http://www.cryptography.com/public/pdf/DPATechInfo.pdf>, and Eric Brier et al., “Correlation Power Analysis with a Leakage Model,” [online], Gemplus Card International, searched on the Internet on Dec. 1, 2017, <https://www.iacr.org/archive/ches2004/31560016/31560016.pdf>.

Various circuits are proposed as a countermeasure against the DPA and CPA attacks. For example, Daisuke Suzuki et al., “Random Switching Logic: A Countermeasure against DPA based on Transition Probability.” [online], International Association for Cryptologic Research, searched on the Internet on Dec. 1, 2017 <http://eprint.iacr.org/2004/346.pdf> propose Random Switching Logic (RSL) circuit and Wave Dynamic Differential Logic (WDDL) circuit. The RSL circuit switches an operational mode of a logic circuit with a random number, so as to eliminate a biased state transition probability, thereby randomizing power consumption to avoid dependence on a cryptographic key. The WDDL circuit reduces a difference in current consumption due to difference in bit values in an arithmetic operation with a complementary circuit after precharging, so as to render the power consumption uniform.

### SUMMARY

A communication system includes a first communication device including first circuitry and a second communication device configured to be connected to the first communication device and including second circuitry. The first circuitry is configured to perform first encryption including first non-linear processing, and perform first decryption including first inverse non-linear processing. The second circuitry being configured to perform second decryption including second inverse non-linear processing, and perform second encryption including second non-linear processing. In transmission of first data from the first communication device to the second communication device, the first circuitry and the second circuitry is configured to selectively switch first processing including encrypting the first data by the first non-linear processing to generate first encrypted data in the first circuitry, and decrypting the first encrypted data by the second inverse non-linear processing in the second circuitry, and second processing including encrypting the first data by the first inverse non-linear processing to generate first encrypted data in the first circuitry, and decrypting the first encrypted data by the second non-linear processing in the second circuitry.

A data communication method between a first communication device including first circuitry configured to perform first encryption including first non-linear processing and first decryption including first inverse non-linear processing, and a second communication device including second circuitry configured to perform second decryption including second inverse non-linear processing and second encryption including second non-linear processing includes selectively switching, in transmission of first data from the first communication device to the second communication device, encrypting the first data by the first non-linear processing to generate first encrypted data, and decrypting the first encrypted data by the second inverse non-linear processing, and encrypting the first data by the first inverse non-linear processing to generate first encrypted data, and decrypting the first encrypted data by the second non-linear processing.

### BRIEF DESCRIPTION OF THE DRAWINGS

FIG. 1 is a diagram illustrating a configuration of a memory system.

FIG. 2 is a diagram illustrating a configuration of encryption-decryption units.

FIG. 3 is a simplified diagram illustrating a typical circuit configuration of encryption units.

FIG. 4 is a simplified diagram illustrating a typical circuit configuration of decryption units.

FIG. 5 is a diagram illustrating encryption and decryption in sending a command from the host device to the memory device.

FIG. 6 is a diagram illustrating encryption and decryption in sending content data from the memory device to the host device.

FIG. 7 is a diagram illustrating an example of a selection table.

FIG. 8 is a simplified diagram illustrating a sequence of readout of content data from the memory device to the host device.

FIG. 9 is a diagram illustrating another example of the selection table.

FIG. 10 is a diagram illustrating another example of the selection table.

FIG. 11 is a simplified diagram illustrating a sequence of readout of content data from the memory device to the host device.

FIG. 12 is a diagram illustrating information input from a CPU to the encryption-decryption unit.

FIG. 13 is a diagram illustrating processing by the encryption-decryption unit.

FIG. 14 is a diagram illustrating information input from the CPU to the encryption-decryption unit.

FIG. 15 is a diagram illustrating processing by the encryption-decryption unit.

FIG. 16 is a simplified diagram illustrating a configuration of the memory system.

FIG. 17 is a simplified diagram illustrating a configuration of the memory system.

FIG. 18 is a diagram illustrating a configuration of the encryption-decryption units.

FIG. 19 is a diagram illustrating common keys managed by the host device and the memory device.

FIG. 20 is a diagram illustrating a method for generating a first and a second common key.

FIG. 21 is a diagram illustrating a method for generating the first and the second common key.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawing. The term “circuitry” herein may partly or entirely be implemented by using either hardware or software, or both hardware and software.

Providing an encryption device with the above-described RSL or WDDL circuit causes increase in arithmetic operation time, circuit size and power consumption by several to several dozen times, in comparison to not providing such circuits, which results in increase in cost.

The present disclosure is directed to a communication system and a data communication method that achieve effective countermeasure against the DPA and CPA attacks readily and at low cost.

A communication system according to an aspect of the present disclosure includes a first communication device including a first encryption-decryption unit, and a second communication device configured to be connected to the first communication device and including a second encryption-decryption unit. The first encryption-decryption unit includes a first encryption unit including a first non-linear processing unit and a first decryption unit including a first inverse non-linear processing unit. The second encryption-decryption unit includes a second decryption unit including a second inverse non-linear processing unit and a second encryption unit including a second non-linear processing unit. In transmission of first data from the first communication device to the second communication device, the first encryption-decryption unit and the second encryption-decryption unit are configured to selectively switch first processing including encrypting the first data with the first non-linear processing unit to generate first encrypted data in the first encryption-decryption unit, and decrypting the first encrypted data with the second inverse non-linear processing unit in the second encryption-decryption unit, and second processing including encrypting the first data with the first inverse non-linear processing unit to generate first encrypted data in the first encryption-decryption unit, and decrypting the first encrypted data with the second non-linear processing unit in the second encryption-decryption unit. The first encryption-decryption unit, the second encryption-decryption unit, the first encryption unit, the first non-linear processing unit, the first decryption unit, the first inverse non-linear processing unit, the second decryption unit, the second inverse non-linear processing unit, the second encryption unit, and the second non-linear processing unit may comprise suitable logic, circuitry, interfaces, and/or code.

In the communication system according to this aspect, in transmission of first data from the first communication device to the second communication device, the first encryption-decryption unit and the second encryption-decryption unit selectively switch first processing including encrypting the first data with the first non-linear processing unit to generate first encrypted data in the first encryption-decryption unit, and decrypting the first encrypted data with the second inverse non-linear processing unit in the second encryption-decryption unit, and second processing including encrypting the first data with the first inverse non-linear processing unit to generate first encrypted data in the first encryption-decryption unit and decrypting the first encrypted data with the second non-linear processing unit in the second encryption-decryption unit. DPA or CPA attacks mainly target the non-linear and the inverse non-linear processing units of the encryption-decryption unit for analysis of power consumption characteristics. Performing transmission of first data from the first communication device to the second communication device by selectively switching the first processing in which the first non-linear processing unit performs encryption and the second inverse non-linear processing unit performs decryption, and the second processing in which the first inverse non-linear processing unit performs encryption and the second non-linear processing unit performs decryption effectively conceals power consumption characteristics of the first encryption-decryption unit and the second encryption-decryption unit. No need for an RSL or WDDL circuit helps avoid increase in cost. In consequence, effective countermeasure against the DPA and CPA attacks is achieved readily and at low cost.

In some embodiments, in transmission of second data in response to the first data from the second communication device to the first communication device, the first encryption-decryption unit and the second encryption-decryption unit are configured to selectively switch third processing including encrypting the second data with the second non-linear processing unit to generate second encrypted data in the second encryption-decryption unit, and decrypting the second encrypted data with the first inverse non-linear processing unit in the first encryption-decryption unit, and fourth processing including encrypting the second data with the second inverse non-linear processing unit to generate second encrypted data in the second encryption-decryption unit, and decrypting the second encrypted data with the first non-linear processing unit in the first encryption-decryption unit.

According to such embodiments, in transmission of second data from the second communication device to the first communication device, the first encryption-decryption unit and the second encryption-decryption unit selectively switch third processing including encrypting the second data with the second non-linear processing unit to generate second encrypted data in the second encryption-decryption unit, and decrypting the second encrypted data with the first inverse non-linear processing unit in the first encryption-decryption unit, and fourth processing including encrypting the second data with the second inverse non-linear processing unit to generate second encrypted data in the second encryption-decryption unit and decrypting the second encrypted data with the first non-linear processing unit in the first encryption-decryption unit. Selectively switching the third processing in which the second non-linear processing unit performs encryption and the first inverse non-linear processing unit performs decryption, and the fourth processing in which the second inverse non-linear processing unit performs encryption and the first non-linear processing unit performs decryption in transmission of second data from the second communication device to the first communication device, as well as transmission of first data from the first communication device to the second communication device, more effectively conceals power consumption characteristics of the first encryption-decryption unit and the second encryption-decryption unit.

In some embodiments, the first communication device further includes a first switching controller configured to control switching between the third processing and the fourth processing by the first encryption-decryption unit. The second communication device further includes a second switching controller configured to control switching between the third processing and the fourth processing by the second encryption-decryption unit. The first switching controller and the second switching controller may comprise suitable logic, circuitry, interfaces, and/or code.

According to such embodiments, the first communication device includes the first switching controller that controls switching between the third processing and the fourth processing by the first encryption-decryption unit. The second communication device includes the second switching controller that controls switching between the third processing and the fourth processing by the second encryption-decryption unit. The first switching controller and the second switching controller synchronously perform switching between the third processing and the fourth processing in the first encryption-decryption unit and switching between the third processing and the fourth processing in the second encryption-decryption unit, by which transmission of second data from the second communication device to the first communication device by the third processing or the fourth processing is performed appropriately.

In some embodiments, the first switching controller and the second switching controller are configured to separately hold a selection table containing a rule for selectively switching between the third processing and the fourth processing, and select between the third processing and the fourth processing by referring to the selection table.

According to such embodiments, the first switching controller and the second switching controller select between the third processing and the fourth processing by referring to a common selection table. No need for selection information for instruction of switching between the third processing and the fourth processing to be sent/received between the first communication device and the second communication device helps avoid increase in communication data between the two devices. The selection table containing an arbitrary rule enables arbitrarily setting a timing and a pattern for switching between the third processing and the fourth processing in advance.

In some embodiments, the first encrypted data includes first selection information on selection between the third processing and the fourth processing. The second switching controller is configured to select between the third processing and the fourth processing, based on the first selection information extracted from the first encrypted data.

According to such embodiments, the second switching controller selects the third processing or the fourth processing, based on the first selection information extracted from the first encrypted data. This enables arbitrarily setting the timing and the pattern for switching between the third processing and the fourth processing by the first communication device.

In some embodiments, the first switching controller and the second switching controller separately include a common counter. The first switching controller and the second switching controller are configured to select between the third processing and the fourth processing, based on a counter value from the counter.

According to such embodiments, the first switching controller and the second switching controller select the third processing or the fourth processing, based on a counter value from the common counter. No need for selection information for instruction of switching between the third processing and the fourth processing to be sent/received between the first communication device and the second communication device helps avoid increase in communication data between the two devices. By employing the counter value, the third processing and the fourth processing are switched irregularly. In consequence, power consumption characteristics are concealed more effectively.

In some embodiments, the first switching controller and the second switching controller separately include a common random number generator. The first switching controller and the second switching controller are configured to select between the third processing and the fourth processing based on a random number value from the random number generator.

According to such embodiments, the first switching controller and the second switching controller select the third processing or the fourth processing, based on a random number value from the common random number generator. No need for selection information for instruction of switching between the third processing and the fourth processing to be sent/received between the first communication device and the second communication device helps avoid increase in communication data between the two devices. By employing a random number value, the third processing and the fourth processing are switched irregularly. In consequence, power consumption characteristics are concealed more effectively.

In some embodiments, if the third processing is selected, the second encryption-decryption unit is configured to dummy-drive the second inverse non-linear processing unit, while if the fourth processing is selected, the second encryption-decryption unit is configured to dummy-drive the second non-linear processing unit.

According to such embodiments, if the third processing is selected, the second encryption-decryption unit dummy-drives the second inverse non-linear processing unit, while if the fourth processing is selected, the second encryption-decryption unit dummy-drives the second non-linear processing unit. Dummy-driving the non-linear processing unit or the inverse non-linear processing unit which is not selected generates largely-distributed power consumption noise by the non-selected non-linear processing unit or inverse non-linear processing unit. In consequence, this power consumption noise effectively conceals the power consumption characteristics of the selected non-linear processing unit and inverse non-linear processing unit.

In some embodiments, the first encryption-decryption unit and the second encryption-decryption unit are configured to select between the third processing and the fourth processing, at every transmission of the second data from the second communication device to the first communication device.

According to such embodiments, the first encryption-decryption unit and the second encryption-decryption unit select the third processing and the fourth processing at every transmission of second data from the second communication device to the first communication device. Switching between the third processing and the fourth processing frequently conceals power consumption characteristics more effectively.

In some embodiments, the first encryption unit and the second decryption unit are configured to generate and decrypt the second encrypted data with one of the first common key and the second common key in the third processing, and the first decryption unit and the second encryption unit are configured to generate and decrypt the second encrypted data with the other of the first common key and the second common key in the fourth processing.

According to such embodiments, the first encryption unit and the second decryption unit generate and decrypt the second encrypted data with one of the first common key and the second common key in the third processing, and the first decryption unit and the second encryption unit generate and decrypt the second encrypted data with the other of the first common key and the second common key in the fourth processing. Employing different common keys in the third processing and the fourth processing effectively makes analysis by a third party difficult.

In some embodiments, if the third processing is selected in a present transmission of the second data, the first encryption-decryption unit and the second encryption-decryption unit are configured to select the first processing in a subsequent transmission of the first data, while if the fourth processing is selected in the present transmission of the second data, the first encryption-decryption unit and the second encryption-decryption unit are configured to select the second processing in the subsequent transmission of the first data.

According to such embodiments, if the third processing is selected in the present transmission of the second data, the first encryption-decryption unit and the second encryption-decryption unit select the first processing in the subsequent transmission of the first data, while if the fourth processing is selected in the present transmission of the second data, the first encryption-decryption unit and the second encryption-decryption unit select the second processing in the subsequent transmission of the first data. The second encryption-decryption unit recognizes which of the first processing and the second processing is to be selected in the subsequent transmission of the first data, depending on which of the third processing and the fourth processing is selected in the present transmission of the second data. This achieves appropriate decryption of the first encrypted data when received from the first communication device in the subsequent transmission by the second decryption unit or the second encryption unit.

In some embodiments, the first communication device further includes a first switching controller configured to control switching between the first processing and the second processing by the first encryption-decryption unit. The second communication device further includes a second switching controller configured to control switching between the first processing and the second processing by the second encryption-decryption unit. The first switching controller and the second switching controller may comprise suitable logic, circuitry, interfaces, and/or code.

According to such embodiments, the first communication device includes the first switching controller that controls switching between the first processing and the second processing by the first encryption-decryption unit. The second communication device includes the second switching controller that controls switching between the first processing and the second processing by the second encryption-decryption unit. The first switching controller and the second switching controller synchronously perform switching between the first processing and the second processing in the first encryption-decryption unit and switching between the first processing and the second processing in the second encryption-decryption unit, by which transmission of first data from the first communication device to the second communication device by the first processing or the second processing is performed appropriately.

In some embodiments, the first switching controller and the second switching controller are configured to separately hold a selection table containing a rule for selectively switching between the first processing and the second processing, and select between the first processing and the second processing by referring to the selection table.

According to such embodiments, the first switching controller and the second switching controller select between the first processing and the second processing by referring to a common selection table. No need for selection information for instruction of switching between the first processing and the second processing to be sent/received between the first communication device and the second communication device helps avoid increase in communication data between the two devices. The selection table containing an arbitrary rule enables arbitrarily setting a timing and a pattern for switching between the first processing and the second processing in advance.

In some embodiments, the first encrypted data includes second selection information on select between the first processing and the second processing for a subsequent transmission of the first data. The second switching controller is configured to select between the first processing and the second processing, based on the second selection information, on completion of processing in response to the first data presently received.

According to such embodiments, the second switching controller selects between the first processing and the second processing, based on the second selection information, on completion of processing in response to the first data presently received. This enables the second encryption-decryption unit to appropriately decrypt the first encrypted data when received from the first communication device in the subsequent transmission by the second decryption unit or the second encryption unit. A combination of the third processing or the fourth processing in response the present first data and the first processing or the second processing for receiving the subsequent first data is arbitrarily selected. In consequence, power consumption characteristics are concealed more effectively.

In some embodiments, the first switching controller and the second switching controller separately include a common counter. The first switching controller and the second switching controller are configured to select between the first processing and the second processing, based on a counter value from the counter.

According to such embodiments, the first switching controller and the second switching controller selects the first processing or the second processing, based on a counter value from the common counter. No need for selection information for instruction of switching between the first processing and the second processing to be sent/received between the first communication device and the second communication device helps avoid increase in communication data between the two devices. By employing the counter value, the first processing and the second processing are switched irregularly. In consequence, power consumption characteristics are concealed more effectively.

In some embodiments, the first switching controller and the second switching controller separately include a common random number generator. The first switching controller and the second switching controller are configured to select between the first processing and the second processing based on a random number value from the random number generator.

According to such embodiments, the first switching controller and the second switching controller select the first processing or the second processing, based on a random number value from the common random number generator. No need for selection information for instruction of switching between the first processing and the second processing to be sent/received between the first communication device and the second communication device helps avoid increase in communication data between the two devices. By employing a random number value, the first processing and the second processing are switched irregularly. In consequence, power consumption characteristics are concealed more effectively.

In some embodiments, if the first processing is selected, the first encryption-decryption unit is configured to dummy-drive the first inverse non-linear processing unit, while if the second processing is selected, the first encryption-decryption unit is configured to dummy-drive the first non-linear processing unit.

According to such embodiments, if the first processing is selected, the first encryption-decryption unit dummy-drives the first inverse non-linear processing unit, while if the second processing is selected, the first encryption-decryption unit dummy-drives the first non-linear processing unit. Dummy-driving the non-linear processing unit or the inverse non-linear processing unit which is not selected generates largely-distributed power consumption noise by the non-selected non-linear processing unit or inverse non-linear processing unit. In consequence, this power consumption noise effectively conceals the power consumption characteristics of the selected non-linear processing unit and inverse non-linear processing unit.

In some embodiments, the first encryption-decryption unit and the second encryption-decryption unit are configured to select between the first processing and the second processing, at every transmission of the first data from the first communication device to the second communication device.

According to such embodiments, the first encryption-decryption unit and the second encryption-decryption unit select between the first processing and the second processing at every transmission of first data from the first communication device to the second communication device. Switching between the first processing and the second processing conceals power consumption characteristics more effectively.

In some embodiments, the first encryption unit and the second decryption unit are configured to generate and decrypt the first encrypted data with one of the first common key and the second common key in the first processing, and the first decryption unit and the second encryption unit are configured to generate and decrypt the first encrypted data with the other of the first common key and the second common key in the second processing.

According to such embodiments, the first encryption unit and the second decryption unit generate and decrypt the first encrypted data with one of the first common key and the second common key in the first processing, and the first decryption unit and the second encryption unit generate and decrypt the first encrypted data with the other of the first common key and the second common key in the second processing. Employing different common keys in the first processing and the second processing effectively makes analysis by a third party difficult.

In some embodiments, the first communication device and the second communication device further include a key generation unit configured to generate the first common key and the second common key based on an identical common key. The key generation unit may comprise suitable logic, circuitry, interfaces, and/or code.

According to such embodiments, the key generation unit generates the first common key and the second common key based on an identical common key. This facilitates generation and management of the first common key and the second common key.

A data communication method between a first communication device including a first encryption unit including a first non-linear processing unit and a first decryption unit including a first inverse non-linear processing unit and a second communication device including a second decryption unit including a second inverse non-linear processing unit and a second encryption unit including a second non-linear processing unit, according to another aspect of the present disclosure, includes, in transmission of first data from the first communication device to the second communication device, selectively switching encrypting the first data with the first non-linear processing unit to generate first encrypted data, and decrypting the first encrypted data with the second inverse non-linear processing unit, and encrypting the first data with the first inverse non-linear processing unit to generate first encrypted data, and decrypting the first encrypted data with the second non-linear processing unit. The first encryption unit, the first non-linear processing unit, the first decryption unit, the first inverse non-linear processing unit, the second decryption unit, the second inverse non-linear processing unit, the second encryption unit, and the second non-linear processing unit may comprise suitable logic, circuitry, interfaces, and/or code.

In the data communication method according to this aspect, in transmission of first data from the first communication device to the second communication device, encryption of first data with the first non-linear processing unit to generate the encrypted data and decryption of the first encrypted data with the second inverse non-linear processing unit, and encryption of first data with the first inverse non-linear processing unit to generate first encrypted data and decryption of the first encrypted data with the second non-linear processing unit are selectively switched. DPA or CPA attacks mainly target the non-linear and the inverse non-linear processing units for analysis of power consumption characteristics. Performing transmission of first data from the first communication device to the second communication device by selectively switching encryption with the first non-linear processing unit and decryption with the second inverse non-linear processing unit, and encryption with the first inverse non-linear processing unit and decryption with the second non-linear processing unit effectively conceals power consumption characteristics of the non-linear processing unit and the inverse non-linear processing unit. No need for an RSL or WDDL circuit helps avoid increase in cost. In consequence, effective countermeasure against the DPA and CPA attacks is achieved readily and at low cost.

Some embodiments of the present disclosure achieve an effective countermeasure against the DPA and CPA attacks readily and at low cost.

These and other objects, features, aspects and advantages of the present disclosure will become more apparent from the following description of embodiments when taken in conjunction with the accompanying drawings.

### Description of Embodiments

Embodiments of the present disclosure are described in detail below referring to the drawings. It should be noted that identical reference numerals throughout the drawings indicate identical or equivalent elements.

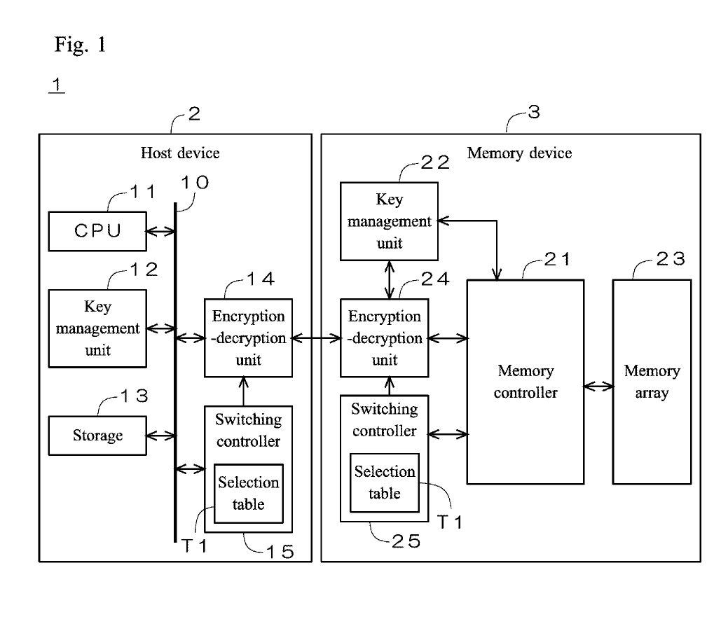

FIG. 1 is a simplified diagram illustrating a configuration of a memory system 1 according to an embodiment of the present disclosure. As illustrated in FIG. 1, the memory system 1 includes a host device 2 and a memory device 3, such as a semiconductor memory, detachably attached to the host device 2.

The host device 2 includes a CPU 11, a key management unit 12, a storage 13, an encryption-decryption unit 14, and a switching controller 15 connected to each other via a bus 10. The switching controller 15 holds a below-described selection table T1 in its internal memory.

The memory device 3 includes a memory controller 21, a key management unit 22, a memory array 23, an encryption-decryption unit 24 similar to the encryption-decryption unit 14, and a switching controller 25. The memory array 23 retains arbitrary data such as content data. The switching controller 25 holds the same selection table T1 as the selection table T1 held in the switching controller 15 in its internal memory.

The host device 2 and the memory device 3 secretly manage an identical common key K0 in the key management units 12 and 22. The encryption-decryption units 14 and 24 perform encryption and decryption on commands sent from the host device 2 to the memory device 3 and content data sent from the memory device 3 to the host device 2. The memory system 1 according to the present embodiment adopts a cryptographic algorithm having a Substitution Permutation Network (SPN) structure in which an encryption circuit and a decryption circuit is independently provided in the encryption-decryption units 14 and 24. Examples of cryptographic algorithms having an SPN structure include Advanced Encryption Standard (AES) and Hierocrypt. The present embodiment employs AES as an example.

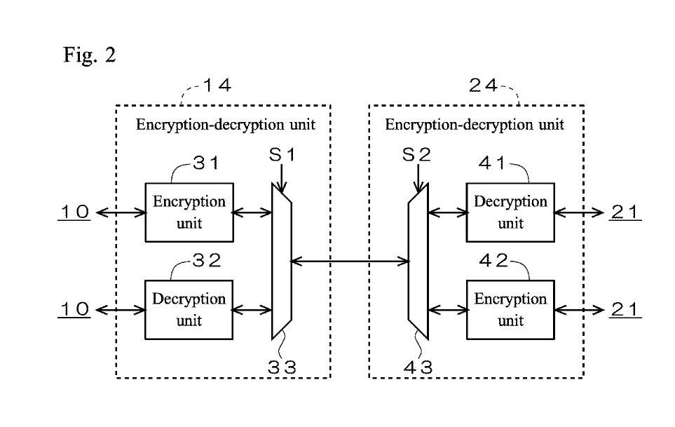

FIG. 2 is a diagram illustrating a configuration of the encryption-decryption units 14 and 24. The encryption-decryption unit 14 includes independently provided encryption unit 31 and decryption unit 32, and a selector 33 for selecting one of the encryption unit 31 and the decryption unit 32 with a control signal S. The encryption-decryption unit 24 includes independently provided encryption unit 42 and decryption unit 41, and a selector 43 for selecting one of the encryption unit 42 and the decryption unit 41 with a control signal S2.

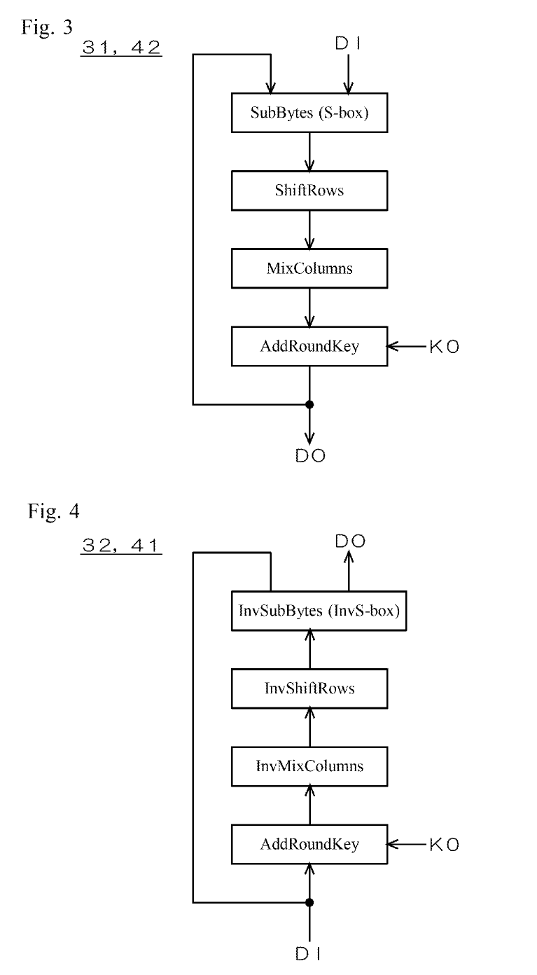

FIG. 3 is a simplified diagram illustrating a typical circuit configuration of the encryption units 31 and 42. As illustrated in FIG. 3, AES is based on a cryptographic algorithm in which four fundamental operations (SubBytes/ShiftRows/MixColumns/AddRoundKey) are repeatedly performed on plaintext data DI having a predetermined number of bits for a predetermined number of rounds to output encrypted data DO. The arithmetic circuit of SubBytes includes a non-linear transformation circuit for performing non-linear transformation called S-box on input data to itself (hereinafter “S-box circuit”). Representative circuit architectures of S-box circuits include a table method where the results of inverse arithmetic and affine transformation are realized by a truth table, and a composite-field technique where independently-provided inverse arithmetic circuit and affine transformation circuit are connected in series. S-box circuits in table method exhibit high resistance to side channel attacks (tamper resistance) with comparatively small power-consumption distribution, while they require large amount of resources. In contrast, S-box circuits based on composite-field technique require small amount of resources, while they exhibit low tamper resistance with comparatively large power-consumption distribution. The present embodiment employs an S-box circuit based on composite-field technique for economy of resources, as an example.

FIG. 4 is a simplified diagram illustrating a typical circuit configuration of the decryption units 32 and 41. Contrary to the encryption units 31 and 42 illustrated in FIG. 3, four fundamental operations (AddRoundKey/InvMixColumns/InvShiftRows/InvSubBytes) are repeatedly performed on encrypted data DI having a predetermined number of bits for a predetermined number of rounds to output plaintext data DO. The arithmetic circuit of InvSubBytes includes an inverse non-linear transformation circuit for performing inverse transformation of the transformation by the S-box circuit (hereinafter “InvS-box circuit”).

Side channel attacks mainly targets the encryption-decryption units 14 and 24 for analysis of power consumption characteristics, especially, the power consumption characteristics of the S-box and the InvS-box circuits that exhibit large power-consumption distribution.

FIG. 5 is a diagram illustrating encryption and decryption in sending a command from the host device 2 to the memory device 3. The encryption-decryption units 14 and 24 are operable to selectively switch between a normal pattern P1 in which the encryption unit 31 encrypts a plaintext command to generate an encrypted command and the decryption unit 41 decrypts the encrypted command and a pattern P2 in reverse to normal in which the decryption unit 32 encrypts a plaintext command to generate an encrypted command and the encryption unit 42 decrypts the encrypted command.

The decryption unit 32 and the encryption unit 42 uses an identical cryptographic algorithm and an identical common key K0, and thus when the decryption unit 32 encrypts and the encryption unit 42 decrypts, an original plaintext command is correctly regenerated. In other words, an identical plaintext command results in an identical decrypted command, whichever of the patterns P1 and P2 is selected.

The S-box circuit of the encryption unit 31 and the InvS-box circuit of the decryption unit 32 employ different transformation tables. Thus an identical original plaintext command results in a different encrypted command. For example, when input data is “0x78”, the S-box circuit outputs “0xBC”, while the InvS-box circuit outputs “0xC1,” causing differences in Hamming distance between input and output data and in variation in Hamming weight between input and output data. The power consumption characteristics are different between the encryption-decryption units 14 and 24, depending on which of the patterns P and P2 is selected.

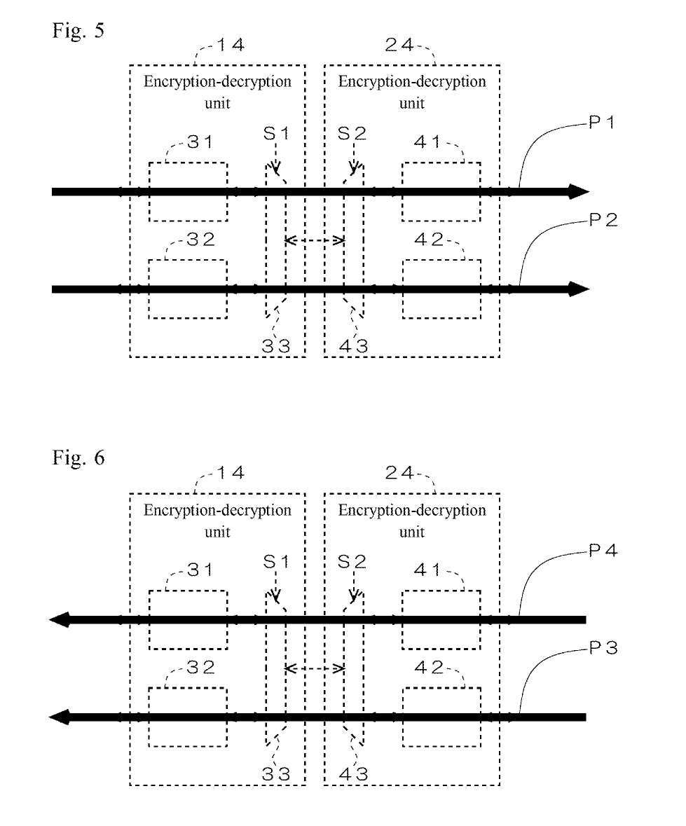

FIG. 6 is a diagram illustrating encryption and decryption in sending content data from the memory device 3 to the host device 2. The encryption-decryption units 14 and 24 are operable to selectively switch between a normal pattern P3 in which the encryption unit 42 encrypts plaintext content data to generate encrypted content data and the decryption unit 32 decrypts the encrypted content data and a pattern P4 in reverse to normal in which the decryption unit 41 encrypts plaintext content data to generate encrypted content data and the encryption unit 31 decrypts the encrypted content data.

Similar to the above, identical plaintext content data results in identical decrypted content data, whichever of the patterns P3 and P4 is selected. The power consumption characteristics are different between the encryption-decryption units 14 and 24, depending on which of the patterns P3 and P4 is selected.

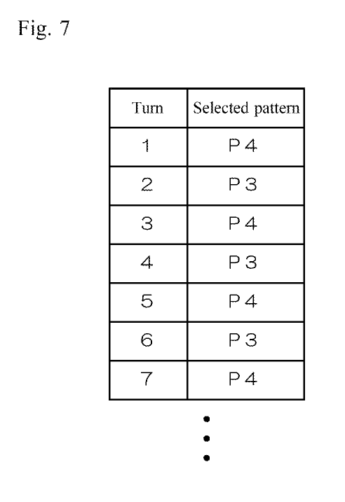

FIG. 7 a diagram illustrating an example of a selection table T1. In the present embodiment, the patterns P3 and P4 are arbitrarily selected at every transmission of content data from the memory device 3 to the host device 2. Information on selection is described in the selection table T1. In the example illustrated in FIG. 7, the selection information is configured such that the pattern P4 is selected at odd-numbered transmissions of content data, while the pattern P3 is selected at even-numbered transmissions of content data.

In the present embodiment, the pattern P1 is selected in the first command transmission after power supply from the host device 2 to the memory device 3. If the pattern P4 is selected in the present transmission of content data, the pattern P2 is selected in the next command transmission, while if the pattern P3 is selected in the present transmission of content data, the pattern P1 is selected in the next command transmission.

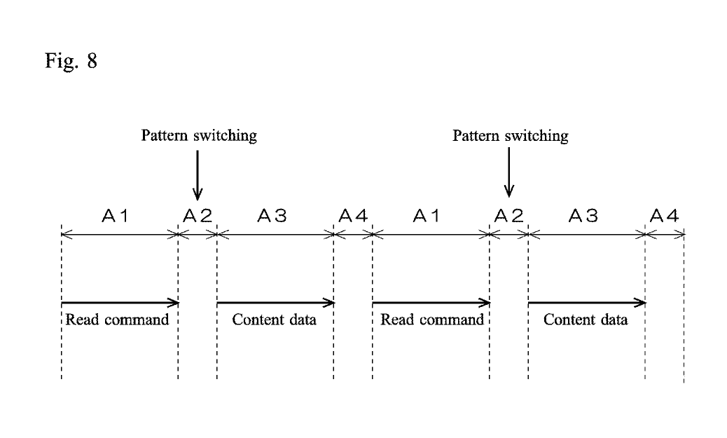

FIG. 8 is a simplified diagram illustrating a sequence of readout of content data from the memory device 3 to the host device 2. In the command transmission period A1, the first read command is sent from the host device 2 to the memory device 3. After a latency period A2 in which a read access to the memory array 23 is performed, content data is sent from the memory device 3 to the host device 2 in a data transmission period A3. After a standby period A4 in which the next read command is awaited, the second read command is sent from the host device 2 to the memory device 3, and from then on, the same operations are repeated. In the present embodiment, the patterns P3 and P4 are selectively switched in the latency period A2.

The operations of the memory system 1 according to the present embodiment are described below with reference to FIGS. 1 to 8.

Referring to FIG. 1, when the memory device 3 is connected to the host device 2 and power is supplied to the memory device 3, the host device 2 and the memory device 3 perform mutual authentication in a predetermined authentication algorithm. On completion of mutual authentication, the CPU 11 issues the first read command. The read command is input to the encryption-decryption unit 14.

Referring to FIG. 5, the encryption-decryption unit 14 encrypts the received read command to generate an encrypted read command. As described above, the memory system 1 according to the present embodiment is configured such that the pattern P1 is selected in the first command transmission. The encryption-decryption units 14 and 24 therefore select the encryption unit 31 and the decryption unit 41 with the control signals S1 and S2 received from the switching controllers 15 and 25. The encryption unit 31 encrypts the read command. The encrypted read command is then sent from the host device 2 to the memory device 3 in the command transmission period A1 (see FIG. 8).

In the latency period A2 (see FIG. 8), the decryption unit 41 decrypts the received encrypted read command. Referring to FIG. 1, the decrypted read command is input to the memory controller 21. On completion of receipt of the read command from the encryption-decryption unit 24, the memory controller 21 issues a receipt completion flag. The receipt completion flag is sent from the memory controller 21 to the host device 2. Triggered by the receipt completion flag, the host device 2 and the memory device 3 select a pattern for transmission of content data. More specifically, the switching controllers 15 and 25 refer to the selection table T1 to select the pattern P3 or P4. Referring to FIG. 7, the selected pattern for the first transmission of content data is set to the pattern P4. The encryption-decryption units 14 and 24 select the encryption unit 31 and the decryption unit 41 with the control signals S1 and S2 received from the switching controllers 15 and 25. The memory controller 21 decodes the read command and reads desired content data from the memory array 23. The content data is input to the encryption-decryption unit 24.

Referring to FIG. 6, the encryption-decryption unit 24 encrypts the received content data to generate encrypted content data. Since the pattern P4 is selected here, the decryption unit 41 encrypts the content data. The encrypted content data is then sent from the memory device 3 to the host device 2 in the data transmission period A3 (see FIG. 8). In the present embodiment, the encryption unit 42 belonging to the non-selected pattern P3 receives no content data, and does not perform encryption of content data.

The encryption unit 31 decrypts the received encrypted content data. Processing on the first read command is then completed.

As described above, the memory system 1 according to the present embodiment is configured such that the pattern P2 is selected in the next command transmission when the pattern P4 is selected in the present transmission of content data. Referring to FIG. 5, the encryption-decryption units 14 and 24 therefore select the decryption unit 32 and the encryption unit 42 with the control signals S1 and S2 received from the switching controllers 15 and 25.

When the CPU 11 issues the second read command, the encryption-decryption unit 14 encrypts the read command by the decryption unit 32, and sends the encrypted read command to the memory device 3. The encryption-decryption unit 24 decrypts the received encrypted read command by the encryption unit 42. Triggered by the receipt completion flag, the switching controllers 15 and 25 select a pattern for transmission of content data. Referring to FIG. 7, the selected pattern for the second transmission of content data is set to the pattern P3. The encryption-decryption units 14 and 24 select the decryption unit 32 and the encryption unit 42 with the control signals S1 and S2 received from the switching controllers 15 and 25. The memory controller 21 inputs desired content data read from the memory array 23 to the encryption-decryption unit 24. The encryption-decryption unit 24 encrypts the content data by the encryption unit 42, and sends the encrypted content data to the host device 2. The encryption-decryption unit 14 decrypts the received encrypted content data by the decryption unit 32. Processing on the second read command is then completed.

As described above, the memory system 1 according to the present embodiment is configured such that the pattern P1 is selected in the next command transmission when the pattern P3 is selected in the present transmission of content data. Referring to FIG. 5, the encryption-decryption units 14 and 24 therefore select the encryption unit 31 and the decryption unit 41 with the control signals S1 and S2 received from the switching controllers 15 and 25.

When the CPU 11 issues the third read command, the encryption-decryption unit 14 encrypts the read command by the encryption unit 31, and sends the encrypted read command to the memory device 3. The encryption-decryption unit 24 decrypts the received encrypted read command by the decryption unit 41. Triggered by the receipt completion flag, the switching controllers 15 and 25 select a pattern for transmission of content data. Referring to FIG. 7, the selected pattern for the third transmission of content data is set to the pattern P4. The encryption-decryption units 14 and 24 select the encryption unit 31 and the decryption unit 41 with the control signals S1 and S2 received from the switching controllers 15 and 25. The memory controller 21 inputs desired content data read from the memory array 23 to the encryption-decryption unit 24. The encryption-decryption unit 24 encrypts the content data by the decryption unit 41, and sends the encrypted content data to the host device 2. The encryption-decryption unit 14 decrypts the received encrypted content data by the encryption unit 31. Processing on the third read command is then completed.

To sum up the above, the pattern P1 is selected in the first command transmission, and the pattern P4 is selected in the first transmission of content data in response. The pattern P2 is selected in the second command transmission, and the pattern P3 is selected in the second transmission of content data in response. The pattern P1 is selected in the third command transmission, and the pattern P4 is selected in the third transmission of content data in response. The same processes as the above are repeated from the fourth transmission and onwards.

FIG. 7 is an example of the selection table T1 according to which the patterns P4 and P3 are alternately selected. This example is nonlimiting. The selection table T1 may contain an arbitrary rule according to which the patterns P3 and P4 are irregularly selected.

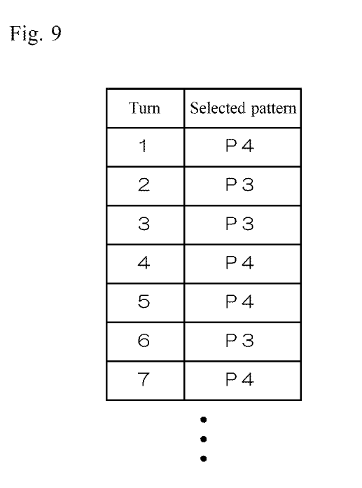

FIG. 9 is a diagram illustrating another example of the selection table T1. In the example illustrated in FIG. 9, the patterns P3 and P4 are irregularly selected such as P4→P3→P3→P4→P4→→P3→P4→ . . . . Uneven selection of one of the patterns P3 and P4 is better avoided. The proportions of the patterns P3 and P4 in selection of predetermined times (for example, 1000 times) are preferably identical (50%).

In the memory system 1 (communication system) according to the present embodiment, the encryption-decryption unit 14 (first encryption-decryption unit) and the encryption-decryption unit 24 (second encryption-decryption unit) selectively switch the pattern P1 (first processing) and the pattern P2 (second processing) in sending a command (first data) from the host device 2 (first communication device) to the memory device 3 (second communication device). According to the pattern P1, the encryption-decryption unit 14 encrypts a command (first encrypted data) with the S-box circuit of the encryption unit 31 (first non-linear processing unit) to generate an encrypted command, and the encryption-decryption unit 24 decrypts the encrypted command with the InvS-box circuit of the decryption unit 41 (second inverse non-linear processing unit). According to the pattern P2, the encryption-decryption unit 14 encrypts a command with the InvS-box circuit of the decryption unit 32 (first inverse non-linear processing unit) to generate an encrypted command, and the encryption-decryption unit 24 decrypts the encrypted command with the S-box circuit of the encryption unit 42 (second non-linear processing unit). DPA or CPA attacks mainly target the S-box and the InvS-box circuits of the encryption-decryption units 14 and 24 for analysis of power consumption characteristics. Performing command transmission from the host device 2 to the memory device 3 by selectively switching the pattern P1 in which the S-box circuit of the encryption unit 31 performs encryption and the InvS-box circuit of the decryption unit 41 performs decryption and the pattern P2 in which the InvS-box circuit of the decryption unit 32 performs encryption and the S-box circuit of the encryption unit 42 performs decryption effectively conceals the power consumption characteristics of the encryption-decryption units 14 and 24. No need for an RSL or a WDDL circuit helps avoid increase in cost. In consequence, effective countermeasure against the DPA and CPA attacks are achieved readily and at low cost.

In the memory system 1 according to the present embodiment, the encryption-decryption units 14 and 24 selectively switch the pattern P3 (third processing) and the pattern P4 (fourth processing) in sending content data (second data) from the memory device 3 to the host device 2. According to the pattern P3, the encryption-decryption unit 24 encrypts content data with the S-box circuit of the encryption unit 42 to generate an encrypted content data (second encrypted data), and the encryption-decryption unit 14 decrypts the encrypted content data with the InvS-box circuit of the decryption unit 32. According to the pattern P4, the encryption-decryption unit 24 encrypts content data with the InvS-box circuit of the decryption unit 41 to generate encrypted content data, and the encryption-decryption unit 14 decrypts the encrypted content data with the S-box circuit of the encryption unit 31. Selectively switching the patterns P3 and P4 in transmission of content data from the memory device 3 to the host device 2, as well as in command transmission from the host device 2 to the memory device 3, more effectively conceals power consumption characteristics of the encryption-decryption units 14 and 24.

In the memory system 1 according to the present embodiment, the host device 2 includes the switching controller 15 (first switching controller) that controls switching between the patterns P and P2 and between the patterns P3 and P4 by the encryption-decryption unit 14, and the memory device 3 includes the switching controller 25 (second switching controller) that controls switching between the patterns P1 and P2 and between the patterns P3 and P4 by the encryption-decryption unit 24. The switching controllers 15 and 25 synchronously perform switching of patterns in the encryption-decryption unit 14 and switching of patterns in the encryption-decryption unit 24, by which command transmission from the host device 2 to the memory device 3 and transmission of content data from the memory device 3 to the host device 2 are performed appropriately with the selected pattern.

In the memory system 1 according to the present embodiment, the switching controllers 15 and 25 refer to the common selection table T1 in selecting the pattern P3 or P4. No need for selection information for instruction of switching between the patterns P3 and P4 to be sent/received between the host device 2 and the memory device 3 helps avoid increase in communication data between the two devices. The selection table T1 containing an arbitrary rule enables arbitrarily setting the timing and the pattern for switching between the patterns P3 and P4 in advance.

In the memory system 1 according to the present embodiment, the switching controllers 15 and 25 select between the patterns P3 and P4 at every transmission of content data from the memory device 3 to the host device 2. Switching the patterns P3 and P4 frequently conceals power consumption characteristics more effectively.

In the memory system 1 according to the present embodiment, when the pattern P3 is selected in the present transmission of content data, the switching controllers 15 and 25 select the pattern P1 in the next command transmission, and when the pattern P4 is select in the present transmission of content data, the pattern P2 is selected in the next command transmission. The encryption-decryption unit 24 recognizes which of the patterns P1 and P2 is to be selected in the next command transmission, depending which of the patterns P3 and P4 is selected in the present transmission of content data. This achieves appropriate decryption of the encrypted command when received from the host device 2 in the next transmission, by the decryption unit 41 or the encryption unit 42.

### Modification 1

In the above embodiment, the switching controllers 15 and 25 arbitrarily select between the patterns P3 and P4, while the patterns P1 and P2 to be selected in the next command transmission depends on selection between the patterns P3 and P4 in the present transmission of content data.

In the present modification, the switching controllers 15 and 25 arbitrarily select between the patterns P1 and P2, as well as between the patterns P3 and P4.

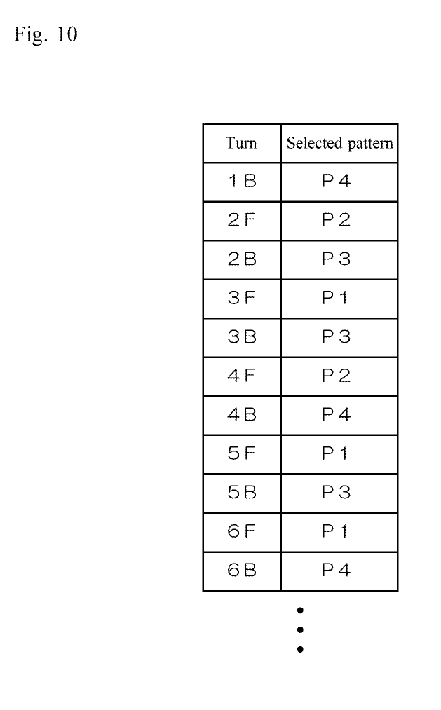

FIG. 10 is a diagram illustrating another example of the selection table T1. In a similar way to the above embodiment, the switching controllers 15 and 25 hold a common selection table T1.

In the present modification, the patterns P3 and P4 are arbitrarily selected at every transmission of content data from the memory device 3 to the host device 2, and the patterns P1 and P2 are arbitrarily selected at every command transmission from the host device 2 to the memory device 3. The selection information is described in the selection table T1. The selection table T1 may contain an arbitrary rule according to which the patterns P1 and P2 and the patterns P3 and P4 are irregularly selected separately. According to the example illustrated in FIG. 10, the pattern P4 is selected in the first transmission of content data (turn 1B), the pattern P2 is selected in the second command transmission (turn 2F), the pattern P3 is selected in the second transmission of content data (turn 2B), the pattern P1 is selected in the third command transmission (turn 3F), and the pattern P3 is selected in the third transmission of content data (turn 3B).

In a similar way to the above embodiment, the pattern P1 is selected in the first command transmission. Uneven selection of one of the patterns P1 and P2 is better avoided. The proportions of the patterns P1 and P2 in selection of predetermined times are preferably identical. This also applies to the patterns P3 and P4.

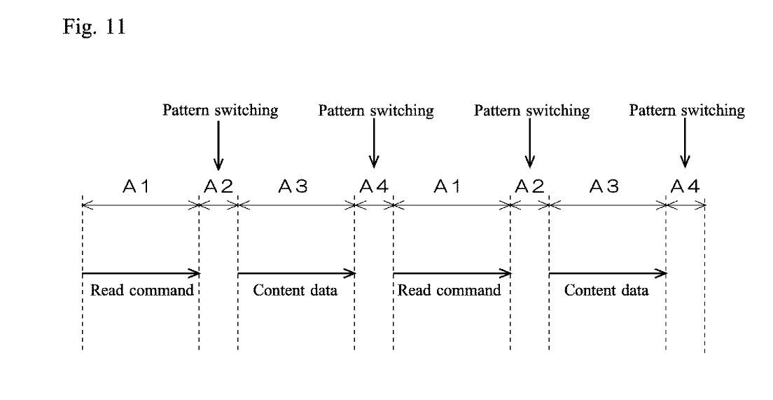

FIG. 11 is a simplified diagram illustrating a sequence of readout of content data from the memory device 3 to the host device 2. In the present modification, selection between the patterns P3 and P4 is performed in the latency period A2, and the selection between the patterns P1 and P2 is performed in the standby period A4.

In the memory system 1 according to the present modification, the switching controllers 15 and 25 arbitrarily select between the patterns P1 and P2 in the next command transmission, irrespective of which of the patterns P3 and P4 is selected in the present transmission of content data. Without constraints between selection between the patterns P3 and P4 in the present transmission of content data and selection between the patterns P1 and P2 in the next command transmission, the patterns P1 and P2 are arbitrarily selected in the next command transmission, which in consequence conceals power consumption characteristics more effectively.

In the memory system 1 according to the present modification, the switching controllers 15 and 25 refer to the common selection table T1 in selecting between the patterns P1 and P2. No need for selection information for instruction of switching between the patterns P1 and P2 to be sent/received between the host device 2 and the memory device 3 helps avoid increase in communication data between the two devices. The selection table T1 containing an arbitrary rule enables arbitrarily setting the timing and the pattern for switching between the patterns P and P2 in advance.

### Modification 2

In the above embodiment, the switching controller 25 refers to the selection table T1 to select between the patterns P3 and P4.

In the present modification, the encryption-decryption unit 14 sends a first selection information for selection between the patterns P3 and P4 along with the encrypted command to the memory device 3, and the switching controller 25 selects between the patterns P3 and P4 on the basis of the first selection information extracted from the received encrypted command.

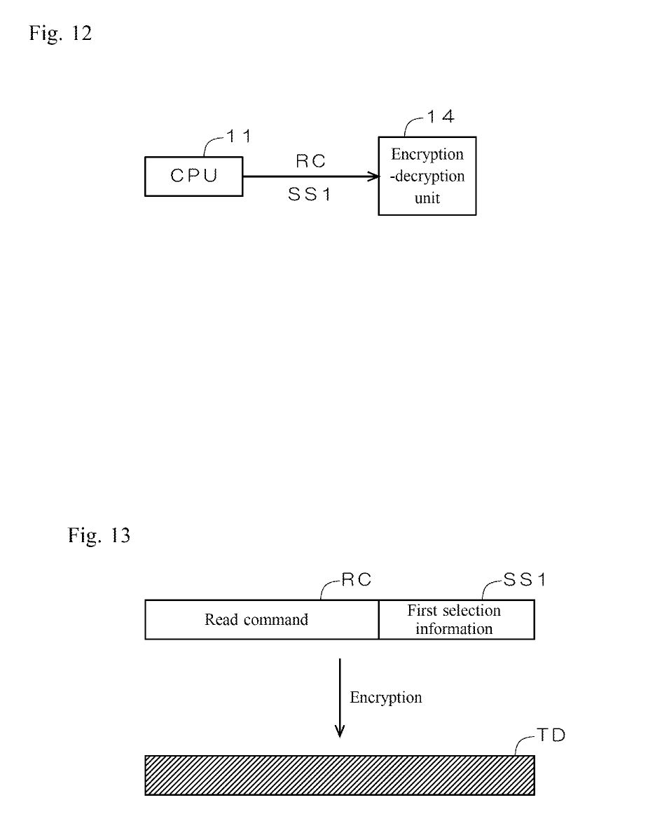

FIG. 12 is a diagram illustrating information input from the CPU 11 to the encryption-decryption unit 14. The CPU 11 inputs a read command RC and a first selection information SS1 for specifying the patterns P3 and P4 to be selected by the encryption-decryption unit 24 in transmission of content data in response to the read command RC to the encryption-decryption unit 14.

FIG. 13 is a diagram illustrating processing by the encryption-decryption unit 14. The encryption-decryption unit 14 adds the first selection information SS1 to the read command RC and encrypts these together to generate an encrypted command TD.

The encryption-decryption unit 24 decrypts the received encrypted command TD and then extracts the first selection information SS1. The switching controller 25 selects the pattern P3 or P4 to be used in transmission of content data in response to the present read command RC on the basis of the first selection information SS. Then the encryption-decryption unit 24 sends content data read from the memory array 23 in accordance with the pattern P3 or P4 selected on the basis of the first selection information SS1 to the host device 2.

In the memory system 1 according to the present modification, the switching controller 25 selects the pattern P3 or P4 on the basis of the first selection information SS1 extracted from the encrypted command TD. This enables arbitrarily setting the timing and the pattern for switching between the patterns P3 and P4 by the CPU 11 of the host device 2.

### Modification 3

In Modification 2, the CPU 11 arbitrarily selects between the patterns P3 and P4. The CPU 11 may arbitrarily select between the patterns P1 and P2, as well as between the patterns P3 and P4.

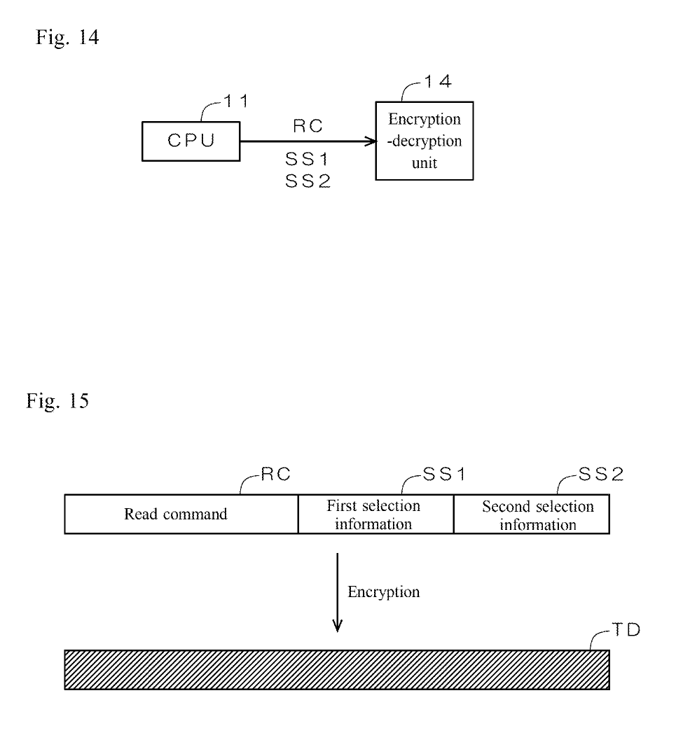

FIG. 14 is a diagram illustrating information input from the CPU 11 to the encryption-decryption unit 14. The CPU 11 inputs the read command RC, the same first selection information SS1 as in Modification 2, and a second selection information SS2 for specifying the patterns P1 and P2 to be selected by the encryption-decryption unit 14 in the next command transmission to the encryption-decryption unit 14.

FIG. 15 is a diagram illustrating processing by the encryption-decryption unit 14. The encryption-decryption unit 14 adds the first selection information SS1 and the second selection information SS2 to the read command RC and encrypts these together to generate an encrypted command TD. The encrypted command TD is sent to the memory device 3 in accordance with the pattern P1 or P2 specified in the previous second selection information SS2.

The encryption-decryption unit 24 decrypts the received encrypted command TD and then extracts the first selection information SS1 and the second selection information SS2. The switching controller 25 selects the pattern P3 or P4 to be used in transmission of content data in response to the present read command RC on the basis of the first selection information SS1. Then the encryption-decryption unit 24 sends content data read from the memory array 23 in accordance with the pattern P3 or P4 selected on the basis of the first selection information SS1 to the host device 2. On completion of transmission of content data, the switching controller 25 selects the pattern P1 or P2 to be used in the next command transmission on the basis of the second selection information SS2.

In the memory system 1 according to the present modification, the switching controller 25 selects the pattern P1 or P2 on the basis of the second selection information SS2 on completion of processing in response to the present command. This enables the encryption-decryption unit 24 to appropriately decrypt an encrypted command when received from the host device 2 in the next transmission by the decryption unit 41 or the encryption unit 42. The CPU 11 arbitrarily selects the combination of the pattern P3 or P4 for processing in response to the present command and the pattern P1 or P2 for receiving the next command. This conceals power consumption characteristics more effectively.

### Modification 4

In the above embodiment, the switching controllers 15 and 25 refer to the selection table T1 in selecting the pattern P1 or P2 in command transmission, and refer to the selection table T1 in selecting the pattern P3 or P4 in transmission of content data.

In the present modification, the switching controllers 15 and 25 perform selection between the patterns P1 and P2 and selection between the patterns P3 and P4 separately on the basis of a common counter value.

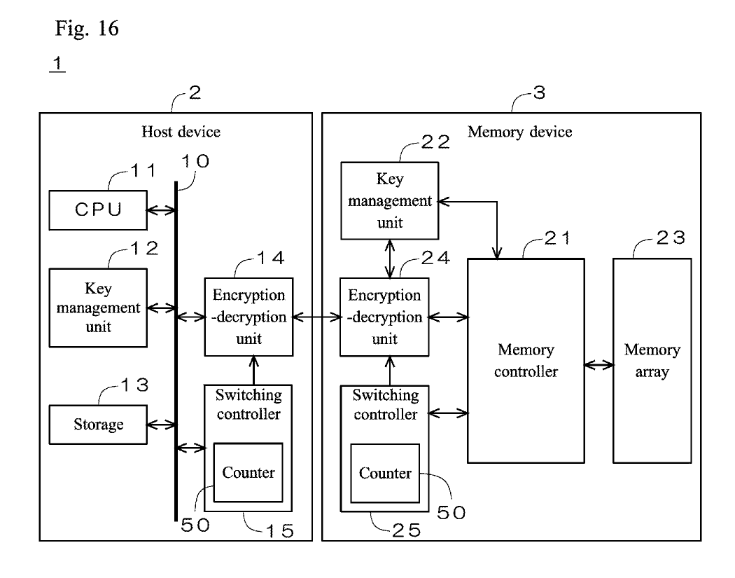

FIG. 16 is a simplified diagram illustrating a configuration of the memory system 1. The host device 2 and the memory device 3 each include a common counter 50. The switching controllers 15 and 25 select the pattern P1 or P2 in command transmission on the basis of a counter value output from the counter 50. The switching controllers 15 and 25 select the pattern P3 or P4 in transmission of content data on the basis of the counter value output from the counter 50. For example, the switching controllers 15 and 25 select patterns in a combination of “P1 and P3” if the counter value having 2 bits output from the counter 50 at a predetermined setting timing is “00,” “P1 and P4” if “01,” “P2 and P3” if “10,” and “P2 and P4” if “11.”

In the memory system 1 according to the present modification, the switching controllers 15 and 25 perform selection between the patterns P1 and P2 and selection between the patterns P3 and P4, on the basis of a counter value output from the common counter 50. No need for selection information for instruction of switching between the patterns P1 and P2 and between the patterns P3 and P4 to be sent/received between the host device 2 and the memory device 3 helps avoid increase in communication data between the two devices. The setting timing based on a counter value varies at each communication, and thus by employing the counter value, the patterns P1 and P2 and the patterns P3 and P4 are switched irregularly. In consequence, power consumption characteristics are concealed more effectively.

### Modification 5

In the above embodiment, the switching controllers 15 and 25 refer to the selection table T1 in selecting the pattern P1 or P2 in command transmission, and refer to the selection table T1 in selecting the pattern P3 or P4 in transmission of content data.

In the present modification, the switching controllers 15 and 25 perform selection between the patterns P1 and P2 and selection between the patterns P3 and P4 separately on the basis of a common random number value.

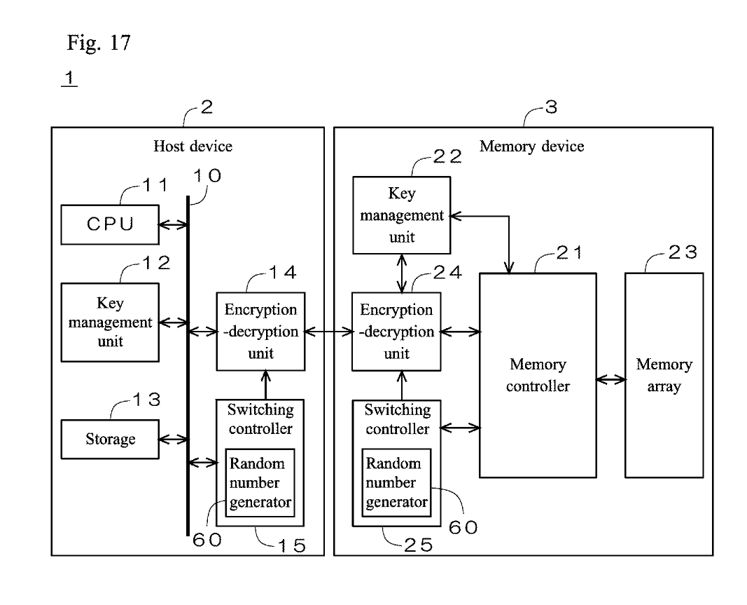

FIG. 17 is a simplified diagram illustrating a configuration of the memory system 1. The host device 2 and the memory device 3 each include a common random number generator 60. The random number generator 60 can be, for example, a pseudo random number generator. The switching controllers 15 and 25 select the pattern P1 or P2 in command transmission on the basis of a random number value output from the random number generator 60. The switching controllers 15 and 25 select the pattern P3 or P4 in transmission of content data on the basis of the random number value output from the random number generator 60. For example, the switching controllers 15 and 25 select patterns in a combination of “P1 and P3” if the random number value having 2 bits output from the random number generator 60 at a predetermined setting timing is “00,” “P1 and P4” if “01,” “P2 and P3” if “10,” and “P2 and P4” if “11.”

In the memory system 1 according to the present modification, the switching controllers 15 and 25 perform selection between the patterns P1 and P2 and selection between the patterns P3 and P4, on the basis of a random number value output from the common random number generator 60. No need for selection information for instruction of switching between the patterns P1 and P2 and between the patterns P3 and P4 to be sent/received between the host device 2 and the memory device 3 helps avoid increase in communication data between the two devices. By employing a random number value, the patterns P1 and P2 and the patterns P3 and P4 are switched irregularly. In consequence, power consumption characteristics are concealed more effectively.

### Modification 6

In the above embodiment, the encryption unit or the decryption unit belonging to a non-selected pattern receives no command and no content data in command transmission and transmission of content data, and the non-selected encryption unit or decryption unit does not perform encryption of a command and content data.

In the present modification, the encryption unit or the decryption unit belonging to a non-selected pattern also receives a command and content data, and performs encryption.

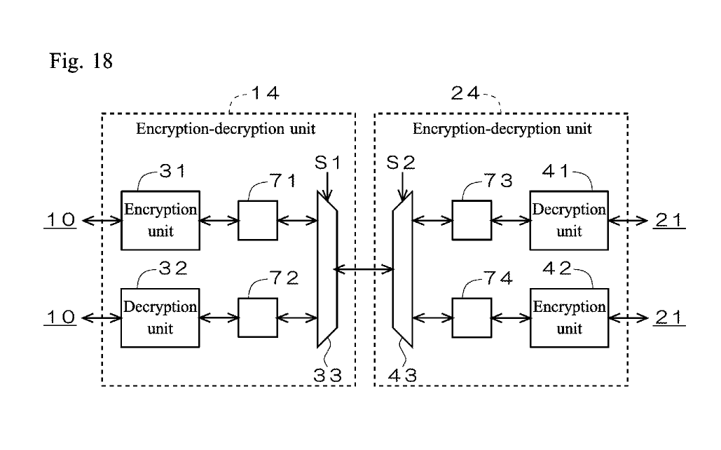

FIG. 18 is a diagram illustrating a configuration of the encryption-decryption units 14 and 24. Buffer circuits 71 and 72 are connected between the encryption unit 31 and the decryption unit 32 and the selector 33, respectively. Similarly, buffer circuits 73 and 74 are connected between the decryption unit 41 and the encryption unit 42 and the selector 43, respectively.

In command transmission, a command issued by the CPU 11 is input to the encryption unit 31 and the decryption unit 32. The encryption unit 31 and the decryption unit 32 encrypt the received command, and input the encrypted command to the buffer circuits 71 and 72, respectively. If the pattern P1 is selected, the encrypted command stored in the buffer circuit 71 is sent to the memory device 3, while if the pattern P2 is selected, the encrypted command stored in the buffer circuit 72 is sent to the memory device 3. The encryption-decryption unit 14 discards the encrypted command stored in the buffer circuit 71 or 72 belonging to the non-selected pattern.

In transmission of content data, content data read from the memory array 23 is input to the decryption unit 41 and the encryption unit 42. The decryption unit 41 and the encryption unit 42 encrypt the received content data, and input the encrypted content data to the buffer circuits 73 and 74, respectively. If the pattern P3 is selected, the encrypted content data stored in the buffer circuit 74 is sent to the host device 2, while if the pattern P4 is selected, the encrypted content data stored in the buffer circuit 73 is sent to the host device 2. The encryption-decryption unit 24 discards the encrypted content data stored in the buffer circuit 73 or 74 belonging to the non-selected pattern.

In the memory system 1 according to the present modification, in command transmission, the encryption-decryption unit 14 dummy-drives the decryption unit 32 if the pattern P1 is selected, while it dummy-drives the encryption unit 31 if the pattern P2 is selected. In transmission of content data, the encryption-decryption unit 24 dummy-drives the decryption unit 41 if the pattern P3 is selected, while it dummy-drives the encryption unit 42 if the pattern P4 is selected. Dummy-driving the encryption unit or the decryption unit belonging to the non-selected pattern generates largely-distributed power consumption noise by the non-selected encryption unit or decryption unit. In consequence, this power consumption noise effectively conceals the power consumption characteristics of the selected encryption unit and the non-linear processing unit.

### Modification 7

In the above embodiment, the encryption-decryption units 14 and 24 employ the common key K0 for both of the patterns P and P2 in command transmission and employ the common key K0 for both of the patterns P3 and P4 in transmission of content data.

In the present modification, the encryption-decryption units 14 and 24 employ common key which are different between the patterns P1 and P2 in command transmission, and employ common keys which are different between the patterns P3 and P4 in transmission of content data.

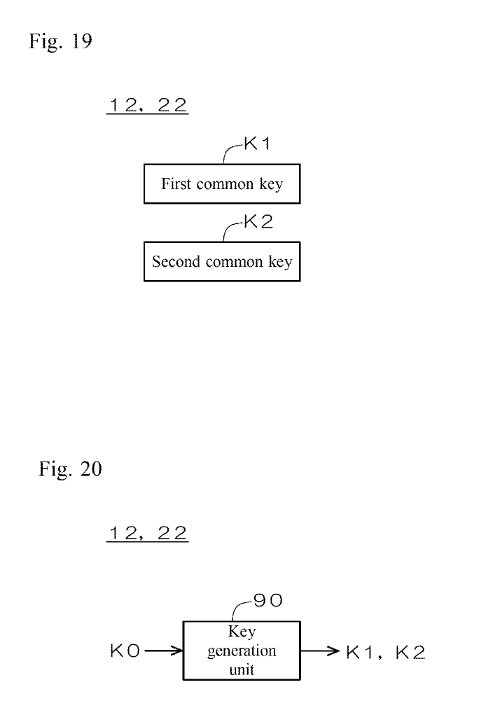

FIG. 19 a diagram illustrating common keys managed by the host device 2 and the memory device 3. In the host device 2, the key management unit 12 manages first common key K1 and second common key K2 different from each other. In the memory device 3, the key management unit 22 manages the same first common key K1 and second common key K2 as the key management unit 12.

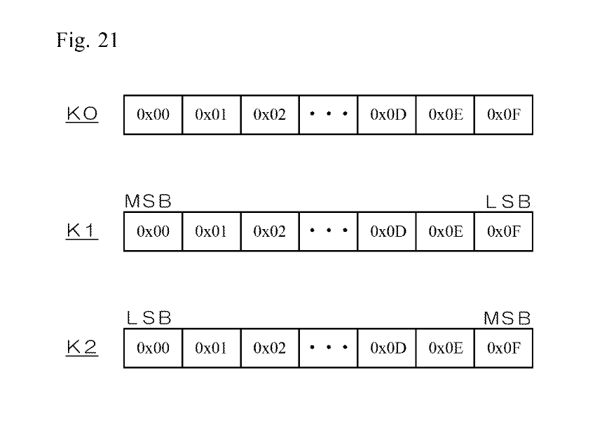

FIGS. 20 and 21 are diagrams illustrating a method for generating the first common key K1 and the second common key K2. As illustrated in FIG. 20, the key management units 12 and 22 include key generation unit 90. The key generation unit 90 generates two keys, namely the first common key K1 and the second common key K2, on the basis of one common key K0. More specifically, as illustrated in FIG. 21, the key generation unit 90 arranges the common key K0 in big endian format to generate the first common key K1, while it arranges the common key K0 in little endian format to generate the second common key K2. Generating two keys, namely the first common key K1 and the second common key K2, on the basis of one common key K0 by the key generation unit 90 facilitates generation and management of the first common key K1 and the second common key K2.

In command transmission, the encryption-decryption units 14 and 24 employ one of the first common key K1 and the second common key K2 if the pattern P1 is selected, while they employ the other if the pattern P2 is selected. Employing different common keys K1 and K2 in the patterns P1 and P2 effectively makes analysis by a third party difficult.

In transmission of content data, the encryption-decryption units 14 and 24 employ one of the first common key K1 and the second common key K2 if the pattern P3 is selected, while they employ the other if the pattern P4 is selected. Employing different common keys K1 and K2 in the patterns P3 and P4 effectively makes analysis by a third party difficult.

The above description is an example of applying embodiments of the present disclosure to the memory system 1 including the host device 2 and the memory device 3. The present disclosure is applicable to any arbitrary communication system where secure communication is realized by encryption between a first and a second communication device configured to be connected to each other. For example, the present disclosure is applicable to the following:
a video processing system including a recording device where video data is stored and a player device for playing the video data received from the recording device;
an information processing system including a recording device where gaming program is stored and a gaming console for executing the gaming program received from the recording device;
a printer system including a toner cartridge and a printer configured to receive information such as remaining amount of toner from the toner cartridge; and
vehicle-installed control system including a target for control, such as an engine, a brake, an accelerator, and an air-conditioner, and a control device configured to communicate information, such as data from sensors and control information, to and from the target.

While the invention has been described in detail, the foregoing description is in all aspects illustrative and not restrictive. It is understood that numerous other modifications and variations can be devised without departing from the scope of the invention.

What is claimed is:

1. A communication system comprising:
a first communication device including first circuitry; and
a second communication device configured to be connected to the first communication device and including second circuitry,
the first circuitry being configured to
perform first encryption including first non-linear processing, and
perform first decryption including first inverse non-linear processing,
the second circuitry being configured to
perform second decryption including second inverse non-linear processing, and
perform second encryption including second non-linear processing,
in transmission of first data from the first communication device to the second communication device, the first circuitry and the second circuitry being configured to selectively switch
first processing including encrypting the first data by the first non-linear processing to generate first encrypted data in the first circuitry, and decrypting the first encrypted data by the second inverse non-linear processing in the second circuitry, and
second processing including encrypting the first data by the first inverse non-linear processing to generate first encrypted data in the first circuitry, and decrypting the first encrypted data by the second non-linear processing in the second circuitry.

2. The communication system according to claim 1, wherein
in transmission of second data in response to the first data from the second communication device to the first communication device, the first circuitry and the second circuitry are configured to selectively switch
third processing including encrypting the second data by the second non-linear processing to generate second encrypted data in the second circuitry, and decrypting the second encrypted data by the first inverse non-linear processing in the first circuitry, and
fourth processing including encrypting the second data by the second inverse non-linear processing to generate second encrypted data in the second circuitry, and decrypting the second encrypted data by the first non-linear processing in the first circuitry.

3. The communication system according to claim 2, wherein
the first circuitry is further configured to control switching between the third processing and the fourth processing, and
the second circuitry is further configured to control switching between the third processing and the fourth processing.

4. The communication system according to claim 3, wherein the first circuitry and the second circuitry are configured to
separately hold a selection table containing a rule for selectively switching between the third processing and the fourth processing, and
select between the third processing and the fourth processing by referring to the selection table.

5. The communication system according to claim 3, wherein
the first encrypted data includes first selection information on selection between the third processing and the fourth processing, and
the second circuitry is configured to select between the third processing and the fourth processing, based on the first selection information extracted from the first encrypted data.

6. The communication system according to claim 3, wherein the first circuitry and the second circuitry are configured to
separately include a common counter, and
select between the third processing and the fourth processing, based on a counter value from the counter.

7. The communication system according to claim 3, wherein the first circuitry and the second circuitry are configured to
separately include a common random number generator, and
select between the third processing and the fourth processing, based on a random number value from the random number generator.

8. The communication system according to claim 2, wherein
if the third processing is selected, the second circuitry is configured to perform dummy processing of the second inverse non-linear processing, while
if the fourth processing is selected, the second circuitry is configured to perform dummy processing of the second non-linear processing.

9. The communication system according to claim 2, wherein
the first circuitry and the second circuitry are configured to select between the third processing and the fourth processing, at every transmission of the second data from the second communication device to the first communication device.

10. The communication system according to claim 2, wherein the first circuitry and the second circuitry are configured to
perform the first encryption and the second decryption in the third processing with one of a first common key and a second common key to generate and decrypt the second encrypted data, and
perform the first decryption and the second encryption in the fourth processing with the other of the first common key and the second common key to generate and decrypt the second encrypted data.

11. The communication system according to claim 10,
wherein the first circuitry and the second circuitry are further configured to
separately generate the first common key and the second common key based on an identical common key.

12. The communication system according to claim 2, wherein
if the third processing is selected in a present transmission of the second data, the first circuitry and the second circuitry are configured to select the first processing in a subsequent transmission of the first data, while
if the fourth processing is selected in the present transmission of the second data, the first circuitry and the second circuitry are configured to select the second processing in the subsequent transmission of the first data.

13. The communication system according to claim 1, wherein
the first circuitry is further configured to control switching between the first processing and the second processing, and
the second circuitry is configured to control switching between the first processing and the second processing.

14. The communication system according to claim 13, wherein the first circuitry and the second circuitry are configured to
separately hold a selection table containing a rule for selectively switching between the first processing and the second processing, and
select between the first processing and the second processing by referring to the selection table.

15. The communication system according to claim 13, wherein
the first encrypted data includes second selection information on selection between the first processing and the second processing for a subsequent transmission of the first data, and
the second circuitry is configured to select between the first processing and the second processing, based on the second selection information, on completion of processing in response to the first data presently received.

16. The communication system according to claim 13, wherein the first circuitry and the second circuitry are configured to
separately include a common counter, and
select between the first processing and the second processing, based on a counter value from the counter.

17. The communication system according to claim 13, wherein the first circuitry and the second circuitry are configured to
separately include a common random number generator, and
select between the first processing and the second processing, based on a random number value from the random number generator.

18. The communication system according to claim 1, wherein
if the first processing is selected, the first circuitry is configured to perform dummy processing of the first inverse non-linear processing, while
if the second processing is selected, the first circuitry is configured to perform dummy processing of the first non-linear processing.

19. The communication system according to claim 1, wherein
the first circuitry and the second circuitry are configured to select between the first processing and the second processing, at every transmission of the first data from the first communication device to the second communication device.

20. The communication system according to claim 1, wherein the first circuitry and the second circuitry are configured to
perform the first encryption and the second decryption in the first processing with one of a first common key and a second common key to generate and decrypt the first encrypted data, and
perform the first decryption and the second encryption in the second processing with the other of the first common key and the second common key to generate and decrypt the first encrypted data.

21. The communication system according to claim 20,
wherein the first circuitry and the second circuitry are further configured to
separately generate the first common key and the second common key based on an identical common key.

22. A data communication method between a first communication device including first circuitry configured to perform first encryption including first non-linear processing and first decryption including first inverse non-linear processing, and a second communication device including second circuitry configured to perform second decryption including second inverse non-linear processing and second encryption including second non-linear processing, the method comprising:
in transmission of first data from the first communication device to the second communication device, selectively switching
encrypting the first data by the first non-linear processing to generate first encrypted data, and decrypting the first encrypted data by the second inverse non-linear processing, and
encrypting the first data by the first inverse non-linear processing to generate first encrypted data, and decrypting the first encrypted data by the second non-linear processing.
